(19) United States
(12) Patent Application Publication
(10) Pub. No.: US 2018/0293632 A1
(43) Pub. Date: Oct. 11, 2018

(54) ITEM CONFIGURATION SYSTEM BASED ON DESIGN AND STYLE MATCHING TECHNIQUE

(71) Applicant: ELSE CORP S.r.l., Milan (IT)

(72) Inventor: Andrey Golub, Milan (IT)

(73) Assignee: ELSE CORP S.r.l., Milan (IT)

(21) Appl. No.: 15/912,053

(22) Filed: Mar. 5, 2018

(30) Foreign Application Priority Data
Mar. 7, 2017 (IT) 102017000025385

(51) Int. Cl. G06Q 30/06; G06F 15/18; G06Q 30/02

(52) U.S. Cl. CPC G06Q 30/0621; G06Q 30/0282; G06F 15/18; G06Q 30/0631

(57) ABSTRACT

It is described a system (100) comprising: at least one processor (1); a user interface (2) associated with a user (6) and cooperating with said at least one processor (1) and a tool module (4) defining instructions that when executed by the at least one processor, cause the system to: select by means of the user interface design features of a first item to configure said first item; store in a database selection information associated with the selections of the design features made by the user; analyze the stored selection information to learn style preferences associated with the user; provide recommendations depending on said style preferences and relating to items to be configured by the user, produce a first item configuration pattern based on said recommendations; propose the first item configuration pattern to the user to perform a style and design matching.

### BACKGROUND

### Technical Field

The present invention relates to item configuration systems based on Artificial Intelligence and on recommendation techniques. Particularly, the present invention refers to the configuration of items belonging to the fashion design, fashion retail and fashion manufacturing industry.

### Description of the Related Art

With reference to fashion industry, online shopping appeared of particular interest. Online shopping is a form of electronic commerce which allows consumers to directly buy goods or services from a seller over the Internet using a web browser. Consumers find a product of interest by visiting the website of the retailer directly or by searching among alternative vendors using a shopping search engine, which displays the same product's availability and pricing at different e-retailers.

Recently, customers can shop online using a range of different computers and devices, including desktop computers, laptops, tablet computers, smartphones, virtual and augmented reality headsets.

Recommendation systems are information filtering systems that seek to predict the “rating” or “preference” that a user would give to an item. Such systems are utilized in a variety of areas: some popular applications include movies, music, news, books, research articles, search queries, social tags, and products in general.

Document US-A-20060282304 describes a system for an electronic product advisor where a suspect list of items that a user already owns or desires to own is programmatically acquired together with relevant ratings, demographic, and behavioral data. This data is then compared to a database of product lists and ratings from similar users. A similarity measure is computed for each product list based on the number of similar products contained on the list that match the consumer's list, rankings, behavioral, and demographic data. A ranked list of recommended products that the consumer does not own is then computed based on the similarity measure and the editorial ratings of the product.

### BRIEF SUMMARY OF THE INVENTION

The Applicant has noticed that fashion design, fashion retail and fashion manufacturing businesses need new technologies and new approaches allowing better meet customer wishes, designer proposals and manufacturer capabilities.

According to a first aspect, the present invention relates to an item configuration system as defined by the appended claim 1. Particular embodiments of the system are described by the dependent claims 2-16. In accordance with another aspect, the present invention relates to an item configuration method defined by independent claim 17.

### BRIEF DESCRIPTION OF THE DRAWINGS

Further characteristics and advantages will be more apparent from the following description of a preferred embodiment and of its alternatives given as a way of an example with reference to the enclosed drawings in which:

FIG. 1 shows an example of an item design configuration system;

FIG. 2 is a flow diagram representing an example of an item design configuration method;

FIG. 3 schematically shows an example of operation of said system;

FIG. 4 show schematically an example of a design configuration step implementable by said method. FIG. 4a shows the item category (shoes) that the user is probably most likely to select. FIG. 4b shows the style of item and its connotation. FIG. 4c shows the parts of the shoe chosen for configuration. FIG. 4d shows the type of the chosen part. FIG. 4e shows the materials and colors for that selected part figure.

### DETAILED DESCRIPTION OF EXAMPLES

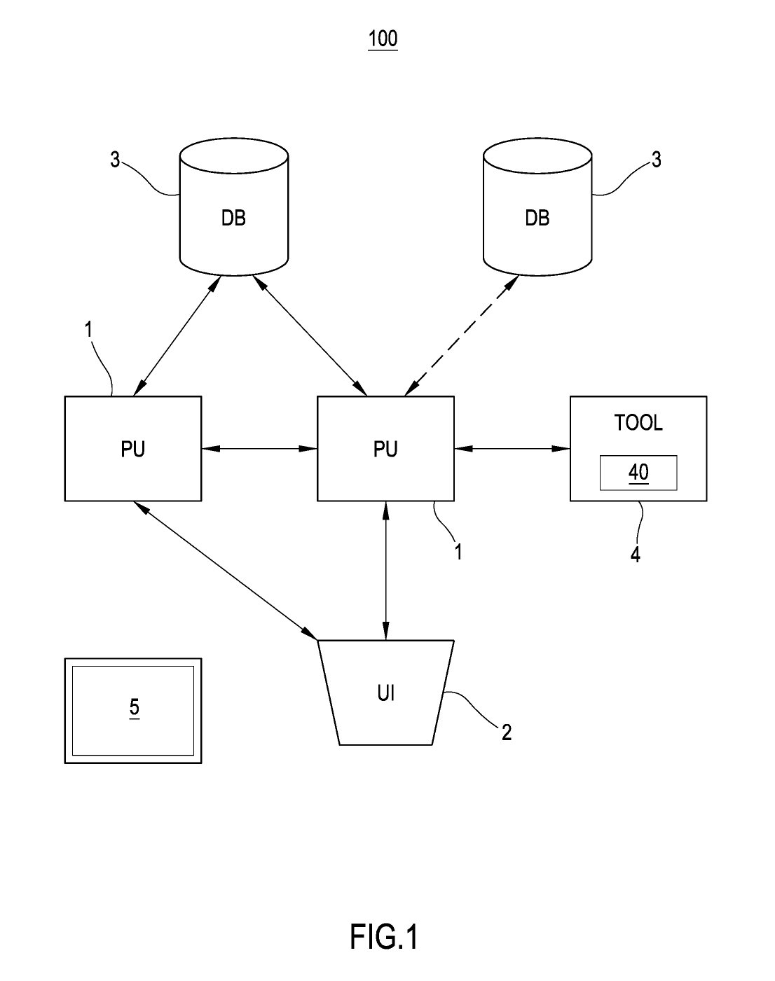

FIG. 1 refers to an example of a configuration and recommendation system 100 which is adapted to learn about customer's style preferences with the end objective of providing recommendation on a configured (personalized or customized) item design to the customer.

Particularly, the configuration and recommendation system 100 (hereinafter, also called “system”) is provided with the following devices: at least one processor 1 (PU), at least one user interface 2 (UI) and one or more databases 3 (DB). The above devices are interconnected each other, as an example, by a telematics net, such as the internet and/or they are part of a cloud or a combination of the two technologies. The connections between the above indicated devices can be wireless, wired or a combination thereof.

The at least one processor 1 can include, as an example, personal computers, mobile devices, servers and client computers or a cloud computing units. According to specific examples, the user interface 2 can be a mobile telephone, a personal computer, a tablet or virtual reality glasses or a keypad, a touch screen of a further electronic device. The user interface 2 can be part of a device having a processor unit that is one of the above mentioned at least one processor 1. The user interface 2 is associated with a user and cooperates with the at least one processor 1 and/or the database 3.

Preferably, the user interface 2 and/or the processor 1 are provided with a display 5 which can upload graphic interfaces useful for the user (also called customer) in operating with the system 100.

The system 100 is also provided with a tool module 4 which is a software module having instructions that can be executed by the at least one processor 1. The tool module 4 allows managing the interactions of the user interface 2 and the other devices to perform a configuring and recommendation method. Particularly, the tool module 4 comprises a company tool module 40 associated with an external company (such as a fashion designer and/or manufacturer) and structured to managing processing made under the control of the external company.

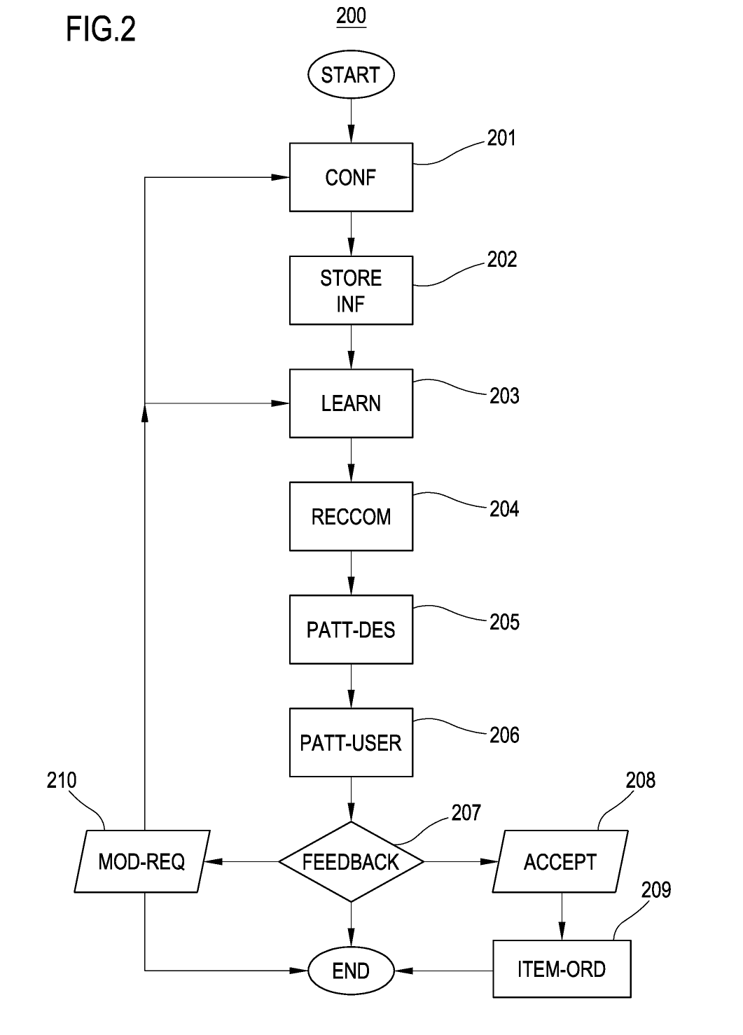

FIG. 2 shows, by a flow diagram, an example of the design configuration method 200 implementable by the tool module 4 of the system 1.

After a start step START, the design configuring method 200 provides for a first step 201 (CONF) in which the user, via the user interface 2, selects available design and manufacturing features of a first item to be designed, i.e. configured.

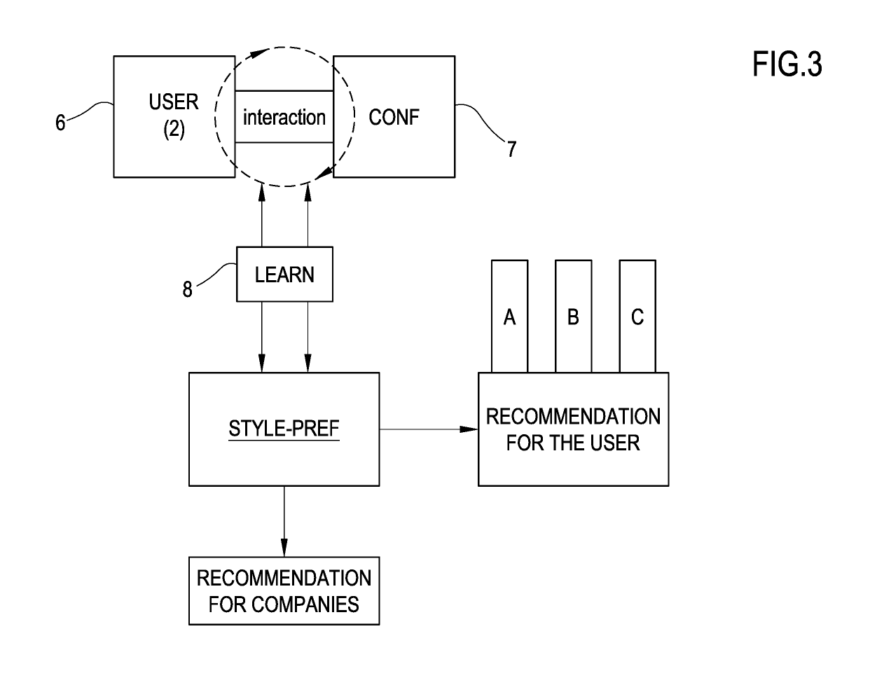

Particularly, the tool module 4 comprises a design configuration module 7 (FIG. 3) which allows a user to configure a specific item by performing a plurality of choices among several options that are proposed to him by the system 100. Preferably, such options are proposed in a visual manner by displaying (as an example, on the display 5) words and/or images and/or symbols corresponding to such options. The representation of the items or part of the items can be made, as an example, using standard Avatar or in a virtual or mixed reality environment.

With the wording “to configure an item” it is meant to define a plurality of manufacturing and or design options and features (among a pre-established set) so as to allow designing the item in a particular way, reflecting to the concept of product customisation. The terms “configuration of an item”, “design of an item” or “design configuration of an item” are interchangeable terminologies according to the present description. As an example, the manufacturing features can relate to the shape of the item, the materials to be employed, the colors and specially to the stylistic design parts, which make the whole item and could have alternative shapes. Moreover, the configuration can relate to manufacturing essential elements and/or to accessory elements and/or purely decorative elements of the item. It is noticed that the item corresponding to the one configured by the user can be already available (i.e. it is already produced/manufactured) or it has to be manufactured on request, according the configuration made in style options and size, where size is also referring to made to measure approach to sizing.

Tool module 4 can be employed to configure items of different typologies primary belonging to the fashion and design industries such as an example, items of clothing (for instance, gowns, suits or elements of them), fashion accessory (for instance, bags, bents etc.), footwear, jewelry, fashion jewelry, watches, accessories for electronic devices, design items, furniture, personal products. Moreover, tool module 4 can be employed to configure design and furniture objects such as tables, chairs, etc. (in the case of design and furniture products, the size and avatar becomes irrelevant, while the basic configuration logic remains similar).

According to an embodiment, the tool module 4 allows the user designing an item from a wide range of unregulated options, similar to the configuration process on a ‘DIY Configurator’, where DIY stay for Do It Yourself.

The design configuration method 200 includes a second step 202 (STORE-INF) in which selection information are stored in the database 3; such selection information relates to the choices made by the user when he have selected the manufacturing features.

Moreover, the user can provide the system with “customer's body data”, i.e. standard for fashion industry measures of the human body such as neck, chest, bust, waist, hips etc., obtained, as an example, from 3D body scanner or specific body part scanner (foot, head, hand).

Furthermore, the tool module 4, in a third step 203 (LEARN), analyzes the stored selection information to obtain, i.e. to learn, style preferences associated with the user. Particularly, the tool module 4 is provided by a learning module 8 (FIG. 3) configured to use Artificial intelligence (AI) to learn about user's style preferences.

In addition, to the learning of the user's style from the analysis of the stored selection information (real-time data), the tool module 4 can learn the user's style from the so called big data. Big data include: past personal purchases, browsing patterns and personal style analytics from similar customer segment purchases (this learning mode is schematically included in the third step 203). The big data can be collected by CRM, ERP, PLM systems, beacons and sensors. The big data can be provided as an input to the company via the further tool module 40.

Moreover, the learning module 8, using the style preferences obtained in the third step 203, generates recommendations in a fourth step 204. Particularly, the recommendations relates to items to be configured by the same user in another configuration session or in the same configuration session.

The learning module 8 performs an analysis of user manipulations (i.e. selections or replacements) by means of mixing the given items parts and options in an intuitive way, towards creation of an “ideal” product configuration, which bring at certain point to satisfactory results, corresponding to the criteria, defined by the user himself: from the satisfactory results the recommendation are obtained.

The recommendations can be provided to the user (e.g. via the user interface 2 or other components of the system 100). Particularly, it is observed that recommendations can be provided (e.g. to the user) at any time throughout the configuration procedure (first step 201), i.e. also when the configuration procedure of the first step 201 is not already ended. The acceptance or the refusal of that recommendation by the user is another information to be employed by the learning module 8 to learn style preferences and provide further recommendation.

At least part of the recommendations outputted by the tool module 4 are provided to the company tool module 40 associated with the external company. The company tool 40 produces, in fifth step 205 (PATT-DES), from said recommendations (and, preferably, also from the stored selection information) an item configuration pattern defining a corresponding configured (i.e. designed) item. As an example, this configured item is obtained from a Computer-Aided Design (CAD) software and possible use of Artificial Intelligence technology. The item configuration pattern can be under the form of a product design template stored into the database or design meta data storage 3, to allow generation on request of different final product design combination, which then become the product articles, with different input parameters, such as “style options” and target client size and measurements.

In a sixth step 206 (PATT-USER), the designed item (corresponding to the first item configuration pattern) is proposed to the user, via the user interface 2, in order to perform a style and design matching confirmation. This initial selection of the configuration pattern could be already the result of Artificial Intelligence application, or be a predefined setup or the results of use of simpler predictable methods.

The user can visualize the proposed configured item and provide a feedback information (seventh step 207—FEEDBACK) to the tool module 4.

The feedback information can be an acceptance of the proposed item: a matching occurred (eighth step 208—ACCEPT). If an acceptance of the proposed item is provided by the user, the tool module 4 can generate a manufacturing order of the corresponding item (ninth step 209—ITEM ORD).

If, alternatively, the user does not accept the proposed item, his/her feedback information represent a modification request (ninth step 210—MOD-REQ). The modification request corresponds (directly or indirectly) to a request of modifying at least some features of the proposed first item: in this case the learning step 203 can be suitable updated considering this feedback information.

The updating of the learning step (third step 203) can cause a repeating of some sub-steps of the configuration step (first step 201) up to the generation of further recommendations, where the methods of Artificial Intelligence based analysis will be involved, to generate more effective learning and adaptation style of recommendations. A second item configuration pattern, based on said further recommendations consequence of the modification request, allows defining a corresponding configured second item to be proposed to the user.

With reference to the ninth step 209, i.e. the item design configuration has been completed according to the user's preferences, the manufacturing order is provided to a manufacturer and, when the item has been produced, it can be delivered to the user.

In addition, the acceptance produced in the eighth step 208 can be saved in a cart or in a “wish list”, as data concerning the configuration made. It is not excluded the case in which an item as designed and ordered is already available and identified in a storeroom.

As an example, the company tool module 40 manages the fifth step 205, the sixth step 206, the seventh step 207, the eighth step 208, the ninth step 209 and the tenth step 210.

FIG. 3 is a schematic and symbolic representation of an example of operation of the system 100. In a configuration session, the user 6 via the user interface 2) interacts with the configuration module 7 (part of the tool module 4).

During such configuration, the user 6 is faced with options and performs his choices; the selection information, corresponding to the choices made, are processed by the learning module 8 (LEARN) operating, particularly, as an AI module, to obtain the style preferences STYLE-PREF that are suitably stored.

The system 100 outputs at least a “recommendation for design systems” (design companies and their used product design tools and systems such as CAD tools) with which the stored style preferences and, preferably, further information on the user, are provided to companies (i.e. brands) and/or manufacturers, as described with reference to the fourth step 204. The knowledge of the style preferences helps companies to offer a specific item to the user 6 or to a cluster of similar users, via the user interface 2, as illustrated with reference to fifth step 205 and the following steps of the method 200.

Moreover, the recommendation outputted by the system 100 can be a “recommendation for the user” with which a suggestion on the item to be configured (chosen on the basis of the stored style preferences) is provided to the user 6, involved in the configuration session.

It is observed that, in accordance with a first specific example, the recommendation for the user can be an already configured item (output A) chosen from several catalogues of different companies that the user can accept or modify during the configuration session.

According to a second example, the recommendation for the user can be an already configured item chosen from a catalogue of a specific company or brand (output B). This recommendation follows the rules and constraints set forth by the brand to stick to the brand's aesthetic and essential features.

In accordance with a third example the recommendation for the user can suggest improvements to the customer's configuration (output C). In this case, these suggestions for improvements are based on some rules and constraints inbuilt into the tool module 4.

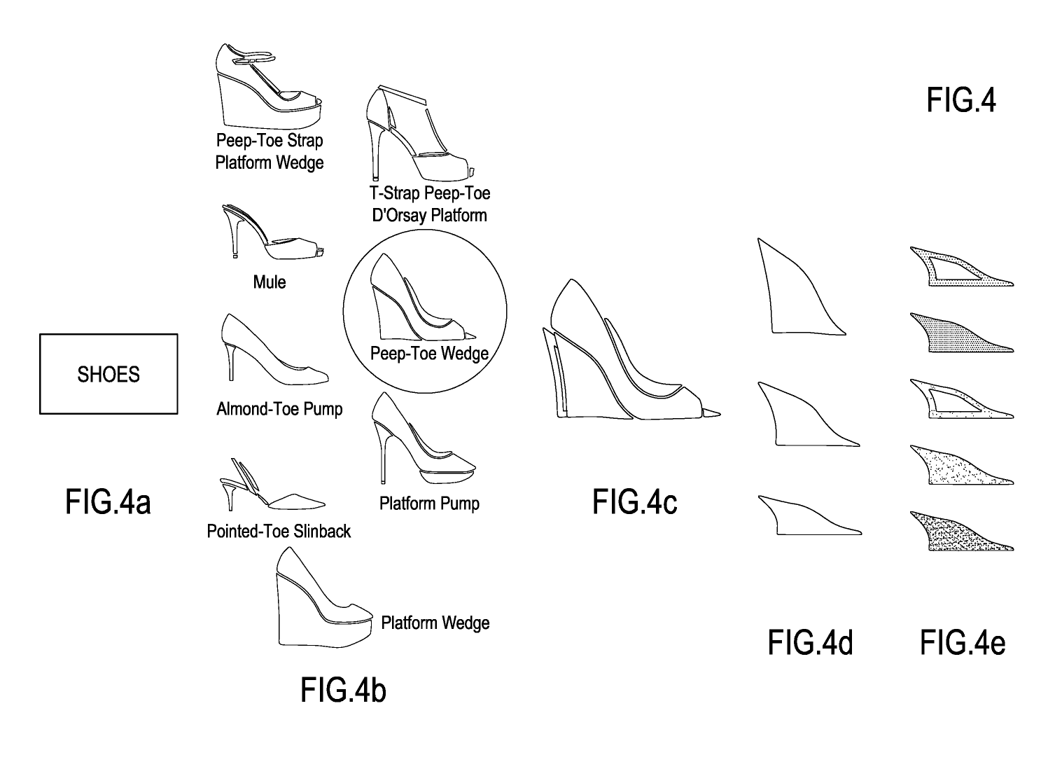

With reference again to the configuration step (i.e. first step 201 of FIG. 2) the users 6 may perform, as an example, the following actions (reference is made to FIG. 4):
select the item category he is interested in (e.g. a SHOE, FIG. 4a);
select the type of shoe (e.g. PEEP-TOE WEDGE SHOE, FIG. 4b);
configure each part of the shoe (e.g. HEEL, FIG. 4c), by selecting the type of part (e.g. WEDGE HEEL, FIG. 4d); and
select the type of materials and colors for that selected part (e.g. BLUE SUEDE, FIG. 4e);

The above actions will be repeated for each part of the selected item type till the user is satisfied with the configuration. The reference to a shoe is only explicative and not limitative.

According to the example of FIG. 4, an exemplary list of information that can be gathered by the tool module 4 in the third step 203 (leaning step) is:
the item category (FIG. 4a) that the user is probably most likely to purchase, since he have actively selected it;
the style of item and its connotation (FIG. 4b): a peep toe, for example, can be considered a more romantic/feminine/girly style of shoe than a pointed toe shoe;
the parts of the shoe chosen for configuration, (FIG. 4c), the type of the chosen part (FIG. 4d); the materials and colors for that selected part FIG. 4e): these information are related to the specific part of the product that is being configured.

So in this example where a heel is being configured, the user's choice of a lowest heel indicated the height that the user is most likely looking for and then the selection of color and material again indicate the preferences of the customer. These steps are repeated for each part of the shoe. The results are attached to the user's profile and result in recommended match products for the customer.

It is noticed that, the more a user uses the system 100, the more accurate the system can get and predict the user's likes and dislikes for particular design item combinations. For example, if four times out of five, a user selects an item with a lower heel, it is an indication that it is more probable that the user will buy a low heeled recommendation.

As an example, also the following information concerning the user's behavior and preferences can be deduced by the tool module 4 from the actions made by the user in the configuration step (first step 201):
the specific occasion/event users are looking for (for that specific instance),
the climate, so it impacts the types of products being recommended (if it is different from what is automatically predicted by the tool),
preferred shapes,
preferred colors,
preferred patterns,
preferred fabrics,
the preferred price range.

It is observed that the tool module 4 learns the user's preferences in a visual way since it learns about user's likes and dislikes from the selections (i.e. the positive choices) made during the configuration procedure, in which the proposed options are displayed. Particularly, the style preferences are not learned by directly asking the user what he likes or dislikes.

In addition, the toll module 4 can learn about customer's preferences basing on an open-ended set of properties and attributes, such as:
brand (e.g. “company name”)
silhouette (e.g. “jeans”)
shape (e.g. “slim cut”)
colour (e.g. “blue”)
material (e.g. “stonewashed cotton denim”)
target groups (e.g. “adult,” “male”)
price range
images selected or ‘disliked’ by the customer (like in the case of e-commerce sites)
customer and expert sentiments

In accordance with a particular embodiment, in order to gain more information on the taste of the user the system 100 and the tool model 4 are configured to incorporate other configurable and selectable elements that may impact on the inference of the preferred style of the customer. So, it is also possible to configure items which do not correspond to products but are general features not necessarily connected to a product, such as: color palettes, textures, images, environments . . . etc . . . .

The tool module 4 of the system 100 can be encountered by users in different possible ways such as: via web or in a physical store of a brand or via virtual, augmented or mixed reality environments. With reference to the web mode, stand-alone website dedicated to the tool integrated in a brand's website or website integrated in a brand's website can be employed.

If the use of system 100 is presented via a physical store of a brand, it can be a part of the configuration experience, to enhance the customer's product configuration. According to alternative solution the use of the system 100 can be presented as a software application offered as promotional activity, where a customer engages with the system and then the brand sends him a similar product at a discounted price or use cross-sale techniques to sell related or similar products. In another possible example, the software application can be provided as a marketing type gimmick.

Particularly, the tool module 4 and the system 100 are configured in such a way that when the customer encounters the tool the customer is aware that he is doing an activity that will enable the system 100 to learn their style preferences. Moreover, the user is also aware that at the end of the activity he will receive certain recommendations and that the data from their activity on the tool gets analyzed and stored.

Reference is now made to information that are already stored in the databases 3 of the system 100, in the case of an existing user. Particularly, the following information are already available and known to the system: customer's size; customer's morphology (Body Type); past purchase history; past browsing history; past configuration history; the location of the customer.

According to an example, the database 3 of system 100 also stores the following inbuilt information, that can be considered as input of the system 100, independent from a particular user: Fashion Trends (in general or specific to a brand's focus); Location based climate (spring, summer, autumn, winter, monsoon . . . ); Cultural factors and influences; Body type specific recommendations; color theory. The inbuilt information can be used by the tool module 4 to infer the style preferences together with the information concerning the user selections.

With reference to the learning step (third step 203), the tool module 4 can be provided with additional sources of preference learning. According to a first additional methodology, since the tool module 4 can operate without keywords searches, the learning can be based on filters (such as: size, prize range etc.) determined by what the customer selects while configuring.

According to a second additional methodology, the configuration step (first step 201) allows cropping from an item image part of the item that the user likes.

According to a third additional methodology, the tool module 4 allows the customer to input images of things that he likes and the user can highlight the specific attribute that he like in that inputted image. As an example, from a picture of a shoe the heel highlighted. According to another example picture of a forest with the green leaves highlighted, indicating the color the customer likes.

According to a fourth additional methodology, the tool module 4, in learning the user's preferences, can use the “human” characteristics of a chat bot/siri like communication.

As regard the configuration of the item, the system 100 can be structured, as an example, in accordance with the system described in the Italian patent application No. 102016000088910.

Further Remarks

The above described design configuring, personalization and recommendation technique shows relevant advantages over the known techniques since it allows providing recommendations based on the actual customer preferences and so it is particularly reliable. The described configuring and recommendation techniques permits to better match customers' preferences with brand's selling activities.

It is noticed that the described system 100 and method 200 represent a sustainable operational model, allowing individual customers (i.e. users) to buy or order unique, highly customized products, in an easy way and produced just-in-time or in a more general way from companies that offer on demand manufacturing.

The above-described technique is an alternative approach to what exists today in the fashion industry. According to the described system, products (items) would be customised, possibly made to measure, and produced on-demand (made to order). But, preferably, an added layer to this is the use of AI to provide each user with a unique product design, customized and to be made just for him/her, that would fit him/her perfectly in size and style. In the end, all the users would have to do is choosing to buy/order the item (and have it manufactured or customized from a pre-manufactured product, allowing such customization) or not.

As clear form the above description, the above described system 100 and method 200 allow learning an individual customer's unique style based on the interactions that customer has with the learning module (particularly, AI based), mixed with other sources of data—which would result in that customer's unique set of ‘style rules’.

As described above, the learned ‘style rules’ of another customers in the database of a specific brand (i.e. a company) or more brands (companies) or an aggregated market intelligence source, would then be used by the brand to filter down the most preferred customisation options and product shapes, resulting in 3d/2D CAD files of ‘product design templates’ that would sell best and that cater to the most number of customers' needs. In the end, the described techniques will allow matching unique customer's style rules with a brand's ‘product design template’ rules best suited to them, with the perfect customisation combinations.

Particularly, the outcome of AI-driven services in this system would be the learned individual, unique ‘style rules’ of each customer, which can be used to help companies to create customisable ‘style templates’ that their customers really want and resulting in the end in an (semi-)automated process of matching a style with a customer.

It is also noticed that the described technique allows facilitating a shift towards a ‘market pull’ approach—going from analytics and business intelligence to the true predictability and better demand planning; personal demand to optimised product design and from the individual product design to its on-demand manufacture.

Product customization on an industrial scale has the potential to bring a high impact change to the whole fashion system, shifting it to the “made to order” manufacturing model. The mass product customization market for luxury fashion alone is estimated to be a $15 Billion opportunity by 2020 in the US only. With the further development of additive and hybrid manufacturing technologies, industrialization of the use of new materials and with the proliferation of the “direct to consumer” business models for the fashion & design industry sectors, a big opportunity for Personal Style Recommendations will (re)open. Suggesting (or “generating”) an ideal product for each individual customer, in the context of “mass customisation”—will lead to the just-in-time manufacturing and in turn, made to order operational model.

Another key impact this would have on the fashion industry is the elimination of the multiple pre-defined sizing systems—which despite being ‘standard’, mean different things to different brands. Each product will be created to the measurements, body shape, structure, particularities, product usage preferences, lifestyle & experience of the individual customer.

1. An item design configuration system (100) comprising:
at least one processor (1);
a user interface (2) associated with a user (6) and cooperating with said at least one processor (1);
a tool module (4) defining instructions that when executed by the at least one processor, cause the system to:
select (201) by means of the user interface design and manufacturing features of a first item to be configured;
store (202) in a database selection information associated with the selections of the design and manufacturing features made by the user via the user interface;
analyze (203) the stored selection information to learn style preferences of the user;
provide recommendations (204) depending on said style preferences and relating to items to be configured by the user;
produce (205) a first item configuration pattern based on said recommendations and defining a corresponding configured first item;
propose (206) the first item configuration pattern to the user to perform a style and design matching;
receive (207) a feedback information from the user on said first item configuration pattern.

2. The system (100) of claim 1, wherein the feedback information is one of the following information: an acceptance (208) of the first item configuration pattern, a modification request (210) of said first item configuration pattern.

3. The system (100) of claim 2, wherein: if an acceptance of the first item configuration pattern is provided by the user, the tool module (4) is structured to generate a manufacturing order (209) of the configured first item.

4. The system (100) of claim 2, wherein: if a modification request of said first item configuration pattern is provided by the user, the tool module (4) is structured to produce a second item configuration pattern based on said recommendations and said modification request, defining a corresponding configured second item.

5. The system (100) of claim 1, wherein said first item configuration pattern is obtained from a Computer-Aided Design software tool.

6. The system (100) of claim 1, wherein the tool module (4) comprises a further tool module (40) associated with an external company and structured to generate the first item configuration pattern, propose the first item configuration pattern to the user and receive the feedback information from the user.

7. The system (100) of claim 5, wherein the further tool module (40) is structured to store in the database a template corresponding to the first item configuration pattern, preferably, independent from sizing and dimensional values of the configured first item, the template is obtained according to an Artificial Intelligence (AI) technique.

8. The system (100) according to claim 1, wherein the tool module (4) is structured to configure at least an item of the group: items of clothing, gowns, suits, fashion accessories, bags, bents, footwear, jewelry, fashion jewelry, watches, accessories for electronic devices, design items, furniture, personal products.

9. The system (100) of claim 1, wherein: the system is structured to make at least part of said recommendations (A, B, C) available to the user.

10. The system (100) of claim 9, wherein said recommendations (A) available to the user indicate an already configured item (output A) chosen from several catalogues of different companies.

11. The system (100) of claim 9, wherein said recommendation (B) available to the user indicates an already configured item chosen from a catalogue of a specific company (output B).

12. The system (100) of claim 9, wherein said recommendation (C) available to the user suggest improvements to the user's selection of the features of an item to be configured.

13. The system (100) of claim 1, wherein the system is provided with a learning module (8) configured to analyze (203) the stored selection information to learn the style preferences associated with the user which operates according to Artificial Intelligence (AI) technique.

14. The system (100) of claim 1, wherein the system is configured to learn style preferences associated with the user from at least one of the following selection information: an item category selected by the user, a style of item, a part of the item selected for configuration, a selected type of the selected part; a material of the selected part, a color of the selected part.

15. The system (100) of claim 1, wherein the tool module (4) comprises a design configuration module (7) which allows a user to configure via said user interface a specific item by performing a plurality of choices among several options that are proposed to the user.

16. The system (100) of claim 15, wherein such design configuration module (7) is configured to:
propose said options to the user in a visual manner by displaying the options on display or by means of holograms or in a virtual, augmented or mixed reality environments;
propose the first item configuration pattern to the user in a visual manner by presenting to the customer the first item configuration pattern.

17. An item design configuration method, comprising:
providing at least one processor (1);
providing a user interface (2) associated with a user (6) and cooperating with said at least one processor (1);
selecting (201) by means of the user interface manufacturing features of a first item to be configured;
storing (202) in a database selection information associated with the selections of the manufacturing features made by the user via the user interface;
analyzing (203) the stored selection information to learn style preferences associated with the user;
outputting recommendations (204) depending on said style preferences and relating to items to be configured by the user;
producing (205) a first item configuration pattern based on said recommendations and defining a corresponding configured first item;
proposing (206) the first item configuration pattern to the user to perform a style and design matching;
receiving (207) a feedback information from the user on said first item configuration pattern.

18. The system (100) of claim 6, wherein the further tool module (40) is structured to store in the database a template corresponding to the first item configuration pattern, preferably, independent from sizing and dimensional values of the configured first item, the template is obtained according to an Artificial Intelligence (AI) technique.
